(19) United States
(12) Patent Application Publication
(10) Pub. No.: US 2011/0158178 A1
(43) Pub. Date: Jun. 30, 2011

(54) SYSTEM AND METHOD OF EDGE CACHING WHEN CUMMUNICATING DATA

(75) Inventors: TIMOTHY D. BOLDUC, WESTFIELD, IN (US); ADEGBILE O. ADEWUNMI, NOBLESVILLE, IN (US); CHRISTOPHER A. HEDGES, GREENTOWN, IN (US); DOUGLAS L. WELK, ROSSVILLE, IN (US)

(73) Assignee: DELPHI TECHNOLOGIES, INC., TROY, MI (US)

(21) Appl. No.: 13/042,517

(22) Filed: Mar. 8, 2011

Related U.S. Application Data
(63) Continuation of application No. 11/899,285, filed on Sep. 5, 2007.

(51) Int. Cl. H04W 4/00

(52) U.S. Cl. 370/328

(57) ABSTRACT

A communication system for distributing data over an area. The system includes a base station configured to transmit common data over a range that is within the area. The system also includes a plurality of nodes, wherein each node is configured to receive the common data from the base station when within the range, receive the common data from another node when within the area, store and transport the common data, transmit the common data to another node within the area, and display the common data. Neither the base station nor nodes individually are capable of transmitting data over the entire area, but the features of the nodes provide for propagating the data by passing the data from node to node when two nodes are within relatively close proximity to each other.

### CROSS-REFERENCE TO RELATED APPLICATION

This application is a continuation of U.S. Ser. No. 11/899,285, filed Sep. 5, 2007, entitled “SYSTEM AND METHOD OF EDGE CACHING WHEN COMMUNICATING DATA”, the entire contents of which are incorporated by reference herein.

### TECHNICAL FIELD OF INVENTION

The present invention generally relates to a system and method of communicating data over an area, and more particularly, a system and method of edge caching when communicating data.

### BACKGROUND OF INVENTION

Edge caching is typically used to transmit data using a master database or base station in addition to other nodes. One example of edge caching is an Internet server, where the main server contains the data for a web site and additional secondary servers receive and save the web site data, such that a personal computer can download the web site data from either the main server or a secondary server. Thus, when the web site data is obtained from the secondary server, the amount of bandwidth transmitted by the main server is reduced.

Another type of network that includes multiple points or nodes that transmit data, in combination with a base station, is a mesh network. Typically, in a mesh network, nodes will communicate with one another to transmit data to another node or base station, with which the node cannot directly communicate with. Thus, the middle nodes are generally nodes that receive the data and re transmit the data to the next node or base station. Generally, nodes in the mesh network transmit the data to a desired location, such that the data propagates through the mesh network until it is received at the desired location.

### SUMMARY OF THE INVENTION

In accordance with one embodiment of this invention, a communication system for distributing data over an area is provided. The system includes a base station and a plurality of nodes. The base station is configured to transmit common data over a range, wherein said range is within the area. Each of the plurality of nodes is configured to receive the common data from the base station when within the range, receive the common data from another node when within the area, store and transport the common data, transmit the common data to another node within the area, and display the common data.

In another embodiment of the present invention, a method of communicating data over an area is provided. The method includes the steps of providing a base station configured to transmit common data over a range, wherein said range is within the area, and providing a plurality of nodes, wherein each node is configured to receive the common data from the base station when within the range, receive the common data from another node when within the area, store and transport the common data, transmit the common data to another node within the area, and display the common data. The method also includes the functional steps of advertising by the base station that the common data is available, receiving the common data by a first node, advertising by the first node that the common data is available, requesting the common data by a second node, and receiving the common data by the second node.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is an environmental view of a communication system in accordance with one embodiment of the present invention;

FIG. 2 is a diagram of a communication system in accordance with one embodiment of the present invention;

FIG. 3A is a flow chart of a portion of a method for communicating data in accordance with one embodiment of the present invention;

FIG. 3B is a flow chart of another portion of the method of communicating data in accordance with one embodiment of the present invention; and

FIG. 4 is a diagram of a communication system in accordance with one embodiment of the present invention.

### DETAILED DESCRIPTION OF INVENTION

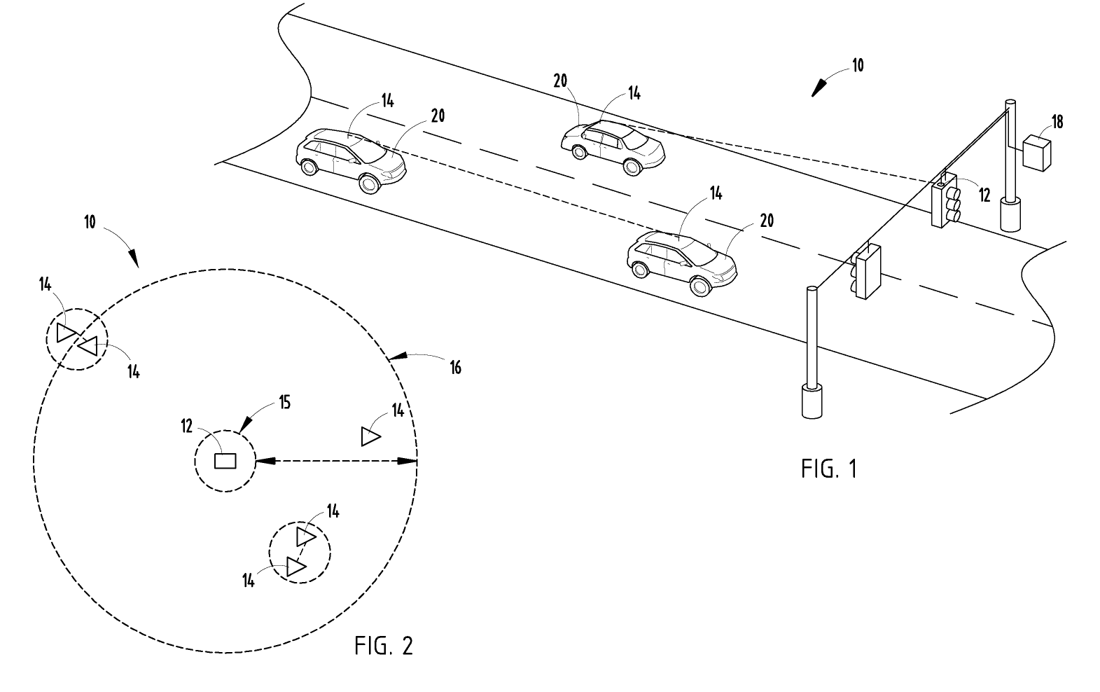

In reference to both FIGS. 1 and 2, a communication system is generally shown at reference identifier 10. The communication system 10 is generally illustrated as a vehicle communication system having at least one base station 12 and a plurality of nodes 14 shown on mobile vehicles 20, according to one embodiment. The base station 12 transmits common data within a range 15 of the base station 12. The plurality of nodes 14 communicate the common data within a predetermined area generally indicated at 16, as described in greater detail herein. Typically, the common data relates to an area greater than the predetermined area 16. The plurality of nodes 14 includes at least a first node that is in communication with the base station 12. Typically, at least a portion of the plurality of nodes 14 is in communication with one another. At least one of the plurality of nodes 14 are mobile and may advertise the common data available for transmission from the node 14 and receive common data from a current node of the plurality of nodes 14 that has current common data or from the base station 12, or a combination thereof.

The communication system 10 further includes a network 18 in communication with the base station 12. Updated common data is entered into the communication system 10 through the network 18, which communicates the updated common data to the base station 12. The network 18 can be a computer, server, or other type of memory or database with which data can be entered into and communicated to the base station 12. The common data can be communicated from the network 18 to the base station 12 through a wire connection or a wireless transmission.

By way of explanation and not limitation, a vehicle infrastructure integration (VII) system generally includes roadside equipment (RSE) stationary nodes and on-board equipment (OBE) mobile nodes, which are typically used with vehicles. However, if the mobile nodes only obtain the desired data from the roadside node, then the bandwidth requirements for transmitting data from the roadside node are very large and difficult to obtain. Thus, the communication system 10 uses mobile edge caching so that the current nodes can transmit current common data to nodes 14, and reduce the amount of transmission bandwidth of the base station 12, as described in greater detail herein. Further, if mobile nodes communicate with one another and the roadside node as a typical mesh network, than an excessive amount of data may be transmitted, since data may be transmitted to mobile nodes that already have that data, which inefficiently uses the transmission bandwidth capabilities of the nodes and roadside node. Additionally, nodes of a standard mesh network typically do not advertise the data contained by the node to other nodes of the base station 12 of the mesh network.

According to a disclosed embodiment, the base station 12 and node 14 can include a transceiver for transmitting and receiving signals or data, and a memory device for storing the data the base station 12 or node 14 receives. The base station 12 and node 14 can further include a processor for processing the signals or data that is transmitted and received by the base station 12 and node 14. It should be appreciated by those skilled in the art that the base station 12 and node 14 can include additional suitable hardware and software for signal processing, data storage, displaying the data, the like, or a combination thereof.

According to one embodiment, the predetermined area 16 is defined for at least a portion of the nodes based upon a geographical location of each of the portion of the nodes, such that the predetermined area 16 is an area of any desired size. For purposes of explanation and not limitation, if one node is within the Chicago metropolitan area, the predetermined area 16 can be defined to include the Chicago metropolitan area, a portion of the Chicago metropolitan area, or the Chicago metropolitan area and surrounding areas. According to an alternate embodiment, the predetermined area 16 for at least a portion of the nodes is dynamically defined. By way of explanation and not limitation, the predetermined area 16 can be dynamically defined based upon the data that is being communicated, such as if the node is within the Chicago metropolitan area, the node will advertise, transmit, and/or request data within a predetermined area defined by the Chicago metropolitan area. The node can then dynamically define the predetermined area to include a geographical area greater than the Chicago metropolitan area if, but not limited to, an emergency message is being broadcast, a traffic situation has arising which affects or has the potential to affect an area greater than the Chicago metropolitan area, data that is not specific to the geographical region, or the like.

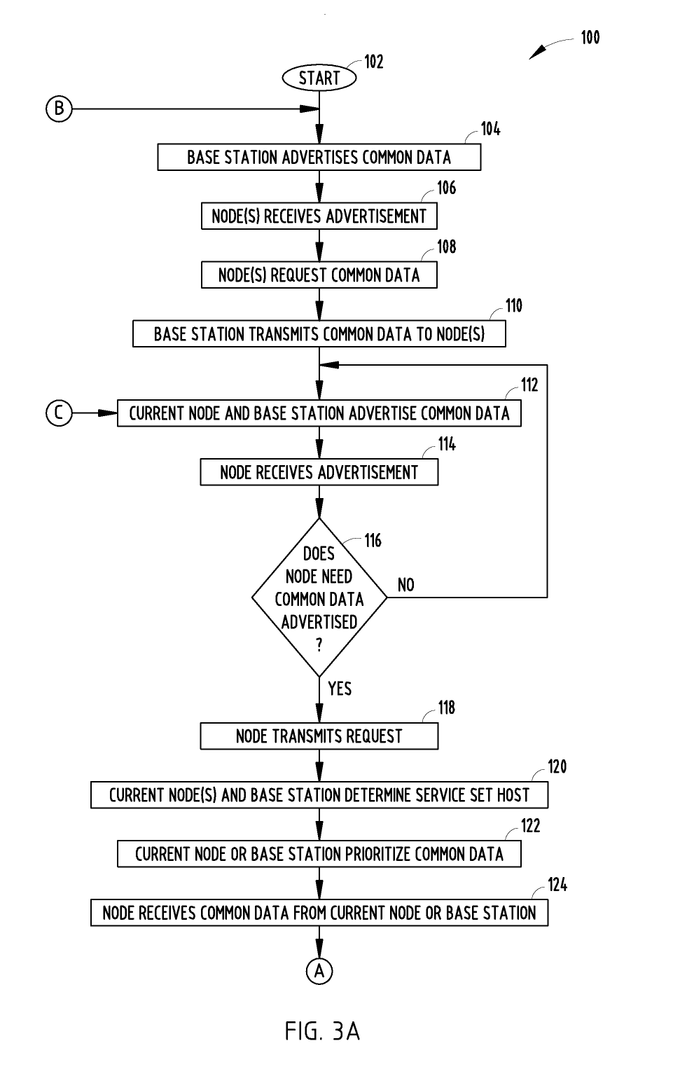

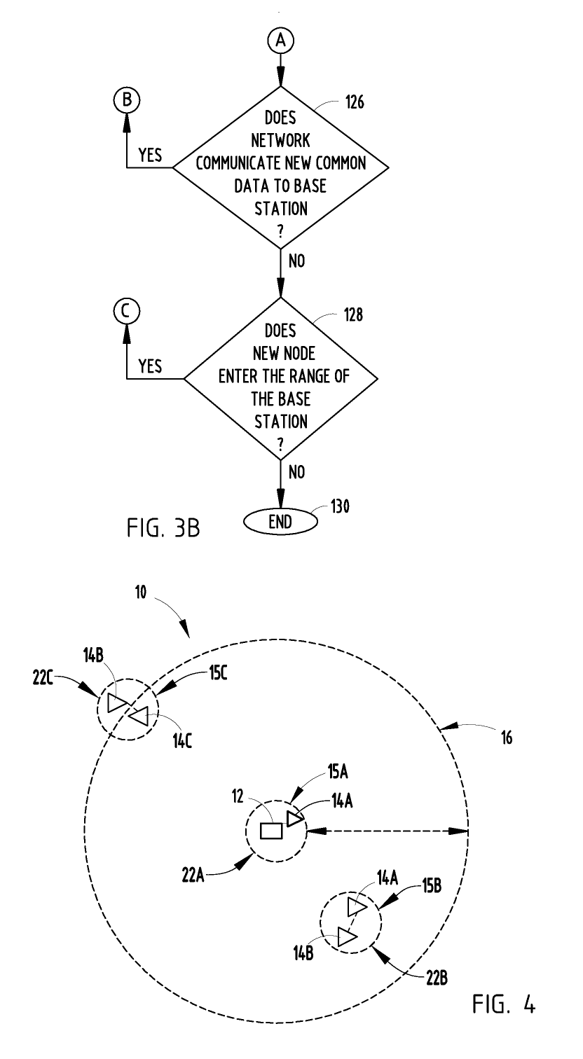

In reference to both FIGS. 3A-3B, a method for communicating data is generally shown in FIGS. 3A and 3B at reference identifier 100. The method 100 starts at step 102, and proceeds to step 104, where the base station 12 advertises common data, which is described in greater detail herein. At step 106, the node 14 receives the advertisement, and the node 14 requests the common data at step 108. At step 110, the base station 12 transmits the common data to the nodes 14. Typically, the common data is identified by a common designator. For purposes of explanation and not limitation, the common data being communicated relates to geographical data, and the common designator “map for this area” designates different common data, depending upon the location of the base station 12 and node 14.

The nodes 14 that receive the common data from the base station 12 are current nodes until the current nodes are determined to be no longer current, because they contain and can transmit the most current common data. Thus, the current nodes are used for mobile edge caching, and a node 14 made current by receiving data from the base station 12 can make another node 14 current by transmitting the current common data to the node 14. According to one embodiment, the node 14 remains a current node after receiving data from the base station 12 or another current node, until any one of the following events occurs: the current node is outside the geographical area defined by the common data it is advertising; it is within a range 15 of another base station 12; the node 14 is turned off; or a predetermined period of time has expired since the current node has received the current common data.

Typically, the advertisements by the base station 12 and current node are only a few bits in size and contain attributes of the larger common data that can be used by the node 14 to determine whether or not it needs the larger sized common data. By way of explanation and not limitation, when the common data being transferred are maps, the advertisement can include a map identification, a revision number, data size, the like, or a combination thereof. According to one embodiment, in order to reduce the amount of bandwidth used by the base station 12 and node 14 for advertisements, the base station 12 and current node can be configured to not send an advertisement for common data that has already been advertised by another current node, not send common data that is related to geographical areas outside the predetermined area 16, has a lower priority than other common data, limit the number of advertisements per current node, or a combination thereof. However, the base station 12 typically always announces the common data that it has available for transmission in order to ensure that new or updated common data can be sent to all nodes 14 within the range 15 of the base station 12.

Alternatively, a current node within the range 15 of the base station 12 will not advertise its common data, since the base station 12 typically continuously advertises the recent common data. However, if the current node receives a request for the common data within the range of the base station 12, the current node can transmit the common data requested to the node 14, rather than the base station 12 in order to minimize the amount of transmission bandwidth used by the base station 12.

Typically, the common data is broken down into small portions or chunks. The nodes 14 can then obtain the entire data sets in pieces, such that the data is efficiently transmitted in smaller portions with a reduced probability of error than if the common data was transmitted in larger portions. Thus, the nodes 14 assemble or combine the portions or chunks. Alternatively, the base station 12 and current nodes 14 can advertise specific portions or chunks, and the nodes 14 can request the specific portions or chunks.

According to one embodiment, a service set or group of nodes 14 that are within communication range of one another, which have information to share or which require the same information, can determine a service set host, which will transmit the common data to the other nodes 14. Typically, the current nodes and/or the base station 12 within the service set determine the service set host using a ranking algorithm. The higher the ranking score, the more ideal it is for that particular current node to be the service set host. For purposes of explanation and not limitation, the ranking score can be determined by considering the signal strength of the requesting node 14, the amount of the requested data the current node can provide, the position and velocity of the requesting node 14, the like, or a combination thereof. The transfer of the common data can occur as a single stream of bytes or in a predetermined portion size. The base station 12 is typically assigned the lowest ranking score, so that any current node that is capable of communicating the common data will transmit the common data to the other nodes 14, rather than the base station 12 in order to minimize the transmission bandwidth of the base station 12. It should be appreciated by those skilled in the art that the current node can be considered no longer current, such as based upon the above algorithm, and the method 100 continues using the base station 12 or another current node to replace the no longer current node, if necessary.

At step 112, the current node and base station 12 advertise the common data, and at step 114, the node 14 receives the advertisement. At decision step 116, it is determined if the node 14 needs the common data advertised. If it is determined that the node 14 does not need the common data advertised, then the method 100 returns to step 112. However, if it is determined at decision step 116 that the node 14 needs the common data advertised, the method 100 proceeds to step 118, where the node 14 transmits a request.

At step 120, the current nodes and the base station 12 determine the service set host, and at step 122, the current node or base station 12 prioritize the common data, so that the data with the highest priority is transmitted first. The node 14 receives the common data from the current node or base station 12 at step 124.

At step 126, it is determined if the network 18 has communicated new data to the base station 12. If the network 18 has communicated new current data to the base station 12, the method 100 returns to step 104, where the base station 12 advertises the common data. However, if at decision step 126, it is determined that the network 18 has not communicated new common data to the base station 12, then the method 100 proceeds to decision step 128. At decision step 128, it is determined if the new node 14 has entered the range 15 of the base station 12. If a new node 14 has entered the range 15, then the method 100 returns to step 112, where the current node and base station 12 advertise the common data. However, if it is determined at decision step 128 that a new node 14 has not entered the range 15, then the method 100 ends at step 130.

Typically, in order for a node 14 to request the common data based upon an advertisement, the node 14 must receive the advertisement, and determine if the common data advertised is needed by the node 14. In an alternate embodiment, the node 14 can determine the common data needed without hearing advertisements based upon an intelligent decision by the node 14 as to the data that should be requested. According to a disclosed embodiment, the intelligent decision can be based upon the desired route generated by a navigation function or device. Alternatively, the intelligent decision can be algorithmically determined based upon parameters dependent upon the data being communicated, the predetermined area of communication, manually entered parameters, the like, or a combination thereof. Thus, the node 14 intelligently determines what data is still needed, and sends a request for such common data.

According to one embodiment, the request contains common data identification, specific portions of the common data requested, the position and velocity of the requesting node 14, the like, or a combination thereof. When the position and velocity are transmitted from the node 14 during the request, the position and velocity of the node 14 can be used to determine the service set host. By way of explanation and not limitation, if a node 14 sends out a request and two nodes are capable of being the service set host, the current node that is traveling in substantially the same direction and same speed as the requesting node 14, will most likely be the service set host, rather than a current node that is traveling in the opposite direction as the requesting node 14, since the nodes 14 traveling in the same direction will remain within communication range with one another for a longer period of time.

According to one embodiment, the intelligent decision by the node 14 can be used as an algorithm based upon determining statistically high community data, such that if the data is requested, there is a high probability that a current node will have the data. By way of explanation and not limitation, statistically high community data is current common data relating to a map for a geographic location within twenty (20) miles of the present location of the node, or current common data relating to a song on the current Top 40 list. Thus, a current node is statistically more likely to have a song in the Top 40 list than an older song not on the Top 40 list. The algorithm can be based upon statistically high community data so that the node 14 does not use bandwidth making an intelligent request for data which it is unlikely that a current node has, when compared to more prevalent current common data.

According to a disclosed embodiment, when the current node is transmitting the common data to a node 14, the service set is maintained until all of the requesting nodes 14 have received the common data, a predetermined time period has expired with no communication, higher priority communications have become necessary, power is removed, or a combination thereof. When such parameters are used, and the service set host and the requesting nodes 14 move out of range of one another, the above algorithm will end the service set and another service set will be formed.

Alternatively, a new service set could begin to be set up, as the nodes 14 in the current service set begin to move out of range of one another. Further, any requesting node 14 that has received the common data and has become a current node can be required to stay within the service set to participate as a current node and provide the common data to the requesting nodes 14. Additionally, if a requesting node 14 enters the service set after the service set host has begun transmitting the current common data, the late arriving node 14 can request the service host to keep the service set active and request the data that it missed. According to yet another embodiment, nodes 14 can participate in multiple service sets simultaneously with different roles in each service set.

By way of explanation and not limitation, in operation, the nodes 14 are used on vehicles 20 in one exemplary embodiment, and the base stations 12 are stationary along the roadside. The common data that is transmitted may include geographical data, such as maps, current traffic conditions, current weather conditions, the like, or a combination thereof. The current nodes are used for mobile edge caching in order to minimize the transmission bandwidth used by the base station 12. Thus, the nodes 14 can communicate common data in the predetermined area 16, such that a node 14 receives the common data prior to being within the range 15 of the base station 12. Further, by using algorithms that limit the amount of transmissions (i.e., advertising and requesting), the amount of transmission bandwidth of the nodes 14 is also minimized. Alternatively, other types of data can also be transmitted using the communication system 10 and method 100, such as music, other entertainment data, or other forms of data that can be transmitted through wireless communication.

As the node 14 enters the predetermined area 16, the node 14 will receive advertisements for the common data, and determine if the node 14 needs the common data. Thus, as the node 14 enters the predetermined area 16, it can determine if the node 14 needs the maps or other common data, which is being transmitted by the current nodes. Therefore, the nodes 14 can receive the common data for the predetermined area 16 with which it is in and other predetermined areas 16, if current nodes contain such data of other predetermined areas 16. Additionally, the data being transferred can be prioritized based upon location and the type of data (e.g., maps, music, etc.).

By way of explanation and not limitation, the system 10 and method 100 may be used in conjunction with a Worldwide Interoperability for Microwave Access (WiMAX) system. Generally, WiMAX is designed to promote conformance of the IEEE 802.16 standard, and to provide wireless data over a distance. However, WiMAX is generally designed to function using cellular communication technology in a defined area. Thus, the system 10 and method 100 could be used with a WiMAX system in order to provide data to mobile nodes 14 while using the mobile nodes 14 for mobile edge caching in order to reduce the transmission bandwidth of the base station 12.

Advantageously, the communication system 10 and method 100 transmit common data to and from mobile nodes using an edge caching technique, such that current nodes transmit the common data in order to minimize the transmission bandwidth of the base station 12. Also, the base station 12 and current nodes advertise the common data that is available in a reduced size in order for the nodes 14 to determine if such common data is needed. Thus, the common data is not being continuously transmitted from one node 14 to another node 14 as a mesh network 18, but the common data is typically transmitted only to those nodes 14, which determine such common data, as needed, and request the common data.

FIG. 4 illustrates a non-limiting example of how the communication system 10 may distribute data over an area 16. The communication system 10 includes a base station 12 that is generally configured to effectively transmit data over a range 15A within the area 16, but is generally by itself not effective to transmit data over the area 16. In order to propagate or distribute data over the area 16, the communication system 10 includes a plurality of nodes: 14A, 14B, and 14C for example. Each node is generally configured to receive the common data from the base station 12 when a particular node within the range 15A. A first node 14A is illustrated as being within the range 15A and so may be able to receive common data from the base station 12. Each of the plurality of nodes is also configured to receive the common data from another of the plurality of nodes. In order to do this, each node of the plurality of nodes is configured to store and transport the common data, for example from within the range 15A to outside of the range 15A, and then later transmit the common data to another node within the area 16.

Like the base station 12, the effective transmit range of any of the nodes is generally less that necessary to effectively transmit data over the entire area 16. FIG. 4 illustrates how the first node 14A may travel within the first range 15A near a first location 22A to receive common data from the base station 12, and then travel elsewhere in the area 16 until, for example, it encounters a second node 14B near a second location 22B. Then, while the first node 14A and the second node 14B are within a second range 15B, the first node 14A may transmit the common data to the second node 14B, thereby propagating or distributing data across area 16 without either the base station 12 or any of the nodes 14A, 14B, and 14C needing the ability to transmit common data over the entire area 16.

If the first node 14A has the same as the common data in the base station 12, then the first node 14A may be characterized as being a current node. It may then be advantageous for communication system 10 to use the current node (first node 14A) instead of the base station 12 to transmit common data to the second node 14B, even if the second node 14B is within the first range 15A of the base station. Such a strategy would free up the base station 12 to perform tasks not capable by the first node 14A, such as downloading updated information directly from the network 18. In this scenario, the current node (i.e.—first node 14A) may be given transmission priority over the base station 12 so that the current node transmits the common data to a second node 14B instead of the base station 12, even if the second node 14B is within the first range 15A.

If the first node 14A has received common data from the base station, then the first node 14A may advertise that common data is available for transmission, for example to the second node 14B if the second node 14B comes within the second range 15B of the first node 14A. If the second node 14B receives such an advertisement, the second node 14B may transmit a request for the common data.

FIG. 4 further illustrates a condition where the second node 14B may travel outside of the area 16, but if it has current data, may provide that data to a third node 14C that is within the area 16 and within a third range 15C near a third location 22C. It will be recognized that this passing along of current data may occur any number of times so that any number of nodes within the area 16 may receive current data without ever traveling within the first range 15A to receive the current data from the base station 12.

In accordance with the description above, a base station 12 configured to transmit common data over a range 15A is provided. Also a plurality of nodes, wherein each node is configured to receive the common data from the base station when within the range, receive the common data from another node when within the area, store and transport the common data, transmit the common data to another node within the area, and display the common data is provided.

Referring again to FIGS. 3A and 3B, step 104 illustrates the step of advertising by the base station 12 that the common data is available. Step 106 illustrates receiving the common data by a first node 14A. Step 112 illustrates advertising by the first node 14A that the common data is available. Step 108 illustrates requesting the common data by a second node 14B. Step 124 illustrates receiving the common data by the second node. Step 126 in conjunction with FIG. 1 illustrates providing a network 18 configured to communicate with the base station 12, wherein updated common data is entered into the network 18 and communicated to the base station 12. Step 128 dynamically defining said area.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

We claim:

1. A communication system for distributing data over an area, said system comprising:
a base station configured to transmit common data over a range, wherein said range is within the area; and
a plurality of nodes, wherein each node is configured to receive the common data from the base station when within the range, receive the common data from another node when within the area, store and transport the common data, transmit the common data to another node within the area, and display the common data.

2. The system in accordance with claim 1, wherein each node is further configured to transmit the common data to another node when the respective nodes are within a second range of each other.

3. The system in accordance with claim 2, wherein a node is characterized as being a current node if the common data stored in the node is the same as the common data in the base station.

4. The communication system of claim 3, wherein the current node has transmission priority over the base station so that the current node transmits the common data to a second node if the second node is within the range of the base station and within a second range of the current node.

5. The system in accordance with claim 1, wherein the system further comprises a network in communication with the base station, wherein updated common data is entered into the network and communicated to the base station.

6. The system in accordance with claim 1, wherein the plurality of nodes includes a first node that received common data from the base station, wherein the first node is configured to advertise that said common data is available for transmission to another node.

7. The system in accordance with claim 6, wherein when a second node receives the advertisement, the second node transmits a request for the common data.

8. The communication system of claim 1, wherein the base station is stationary and at least one of said plurality of nodes is connected to a vehicle.

9. A method of communicating data over an area, said method comprising the steps of:
providing a base station configured to transmit common data over a range, wherein said range is within the area; and
providing a plurality of nodes, wherein each node is configured to receive the common data from the base station when within the range, receive the common data from another node when within the area, store and transport the common data, transmit the common data to another node within the area, and display the common data;
advertising by the base station that the common data is available;
receiving the common data by a first node;
advertising by the first node that the common data is available;
requesting the common data by a second node; and
receiving the common data by the second node.

10. The method of claim 9 further comprising the step of providing a network configured to communicate with the base station, wherein updated common data is entered into the network and communicated to the base station.

11. The method of claim 9 further comprising the step of dynamically defining said area.
